(19) United States
(12) Patent Application Publication
(10) Pub. No.: US 2024/0004052 A1
(43) Pub. Date: Jan. 4, 2024

(54) WIRELESS COMMUNICATION METHODS, WIRELESS COMMUNICATION SYSTEMS, AND RADIO WAVE REFLECTORS

(71) Applicant: NIPPON TELEGRAPH AND TELEPHONE CORPORATION, Tokyo (JP)

(72) Inventors: Riku OMIYA, Musashino-shi, Tokyo (JP); Masashi IWABUCHI, Musashino-shi, Tokyo (JP); Tomoki MURAKAMI, Musashino-shi, Tokyo (JP); Tomoaki OGAWA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/038,558

(22) PCT Filed: Dec. 2, 2020
(86) PCT No.: PCT/JP2020/044909

§ 371 Date: May 24, 2023

(51) Int. Cl. G01S 13/46; G01S 13/89

(52) U.S. Cl. CPC G01S 13/46; G01S 13/89

(57) ABSTRACT

A wireless communication method according to an embodiment includes: capturing an image by each of radio wave reflection devices; detecting a position of a person captured in the image on the basis of the image captured by each of the radio wave reflection devices; determining whether or not each of propagation paths between a reflection unit and a wireless terminal is in a line of sight on the basis of the detected position of the person and the compass information transmitted by the wireless terminal; selecting the radio wave reflection device in which the propagation path between the reflection unit and the wireless terminal is in the line of sight on the basis of each piece of line-of-sight information indicating a result of the determination; and performing control such that the wireless terminal and the base station perform wireless communication using radio waves reflected by the selected radio wave reflection device.

### TECHNICAL FIELD

The present invention relates to a wireless communication method, a wireless communication system, and a radio wave reflection device.

### BACKGROUND ART

In wireless communication systems using high frequency bands such as millimeter waves, for example, radio wave reflection devices (including reflectors and the like) that reflect radio waves between a base station and a wireless terminal and relay communication are known. Some radio wave reflection devices include a dynamic reflector (intelligent reflecting surface (IRS) or the like) capable of controlling phases of incoming waves when reflecting radio waves. A radio wave reflection device including a dynamic reflector can expand a range in which wireless communication can be performed by changing the reflection direction of the radio waves.

In addition, Patent Literature 1 discloses a technique of capturing an image indicating a situation around a base station by a camera and determining the presence or absence of a shield that degrades wireless communication between the base station and a user terminal.

### CITATION LIST

### Patent Literature

Patent Literature 1: Japanese Patent No. 6534641

### SUMMARY OF INVENTION

### Technical Problem

However, when a human (person) holds and uses the wireless terminal, radio waves such as millimeter waves may be blocked depending on the orientation of the human body. That is, even if the radio wave reflection device radiates radio waves toward the wireless terminal, there is a problem that the radio waves do not sufficiently reach the wireless terminal because the human body blocks the radio waves.

The present invention has been made in view of the above-described problems, and an object of the present invention is to provide a wireless communication method, a wireless communication system, and a radio wave reflection device capable of preventing a human body from blocking radio waves from a wireless terminal used by a person.

### Solution to Problem

According to one aspect of the present invention, there is provided a wireless communication method in which a plurality of radio wave reflection devices reflect radio waves transmitted by a base station toward a wireless terminal capable of transmitting compass information while a person is looking at a display screen, the wireless communication method including: a reflection step in which each of the radio wave reflection devices reflects radio waves with a reflection unit; an imaging step of capturing an image by each of the radio wave reflection devices; a detection step of detecting a position of a person captured in the image on the basis of the image captured by each of the radio wave reflection devices; a determination step of determining whether or not each of propagation paths between the reflection unit and the wireless terminal is in a line of sight on the basis of the detected position of the person and the compass information transmitted by the wireless terminal; a selection step of selecting the radio wave reflection device in which the propagation path between the reflection unit and the wireless terminal is in the line of sight on the basis of each piece of line-of-sight information indicating a result of the determination; and a control step of performing control such that the wireless terminal and the base station perform wireless communication using radio waves reflected by the selected radio wave reflection device.

Further, according to one aspect of the present invention, there is provided a wireless communication system in which a plurality of radio wave reflection devices reflect radio waves transmitted by a base station toward a wireless terminal capable of transmitting compass information while a person is looking at a display screen, in which each of the radio wave reflection devices includes: a reflection unit configured to reflect a radio wave; an imaging unit configured to capture an image; a detection unit configured to detect a position of a person captured in the image on the basis of the image captured by the imaging unit; a determination unit configured to determine whether or not a propagation path between the reflection unit and the wireless terminal is in a line of sight on the basis of the position of the person detected by the detection unit and the compass information transmitted by the wireless terminal; and a transmission unit configured to transmit, to the base station, line-of-sight information indicating a result determined by the determination unit, and the base station includes: a reception unit configured to receive the line-of-sight information from each of the radio wave reflection devices; a selection unit configured to select the radio wave reflection device in which the propagation path between the reflection unit and the wireless terminal is in the line of sight on the basis of each piece of the line-of-sight information received by the reception unit; and a control unit configured to perform control such that the wireless terminal and the base station perform wireless communication using radio waves reflected by the radio wave reflection device selected by the selection unit.

Further, according to one aspect of the present invention, there is provided a radio wave reflection device that reflects radio waves transmitted by a base station toward a wireless terminal capable of transmitting compass information while a person is looking at a display screen, the radio wave reflection device including: a reflection unit configured to reflect a radio wave; an imaging unit configured to capture an image; a detection unit configured to detect a position of a person captured in the image on the basis of the image captured by the imaging unit; a determination unit configured to determine whether or not a propagation path between the reflection unit and the wireless terminal is in a line of sight on the basis of a position of a person detected by the detection unit and compass information transmitted by the wireless terminal; and a transmission unit configured to transmit, to the base station, line-of-sight information indicating a result determined by the determination unit.

### Advantageous Effects of Invention

According to the present invention, it is possible to prevent the human body from blocking radio waves from the wireless terminal used by the person.

### BRIEF DESCRIPTION OF DRAWINGS

FIG. 1 is a diagram schematically illustrating a configuration example of a wireless communication system according to an embodiment.

FIG. 2 is a functional block diagram illustrating functions of a radio wave reflection device according to the embodiment.

FIG. 3 is a functional block diagram illustrating functions of a base station.

FIG. 4 is a flowchart illustrating an operation example of the radio wave reflection device according to the embodiment.

FIG. 5 is a flowchart illustrating an operation example of the base station.

### DESCRIPTION OF EMBODIMENTS

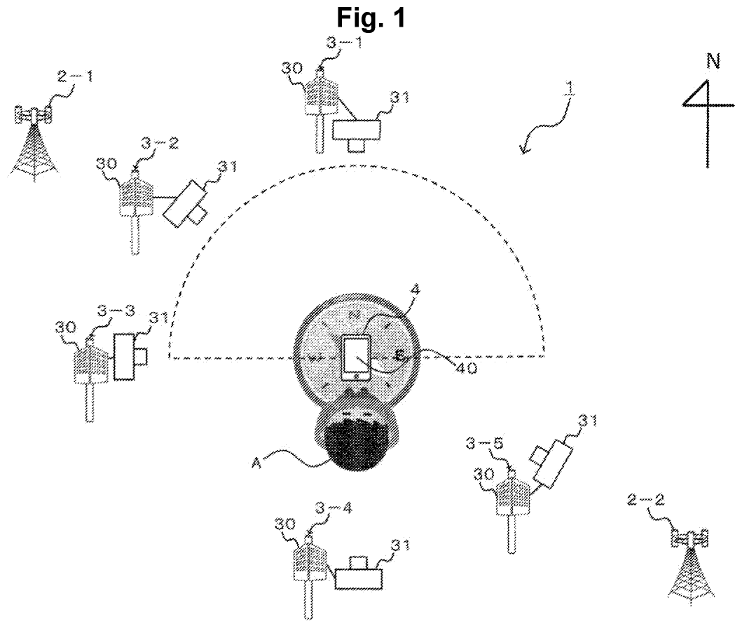

Hereinafter, an embodiment of a wireless communication system will be described with reference to the drawings. FIG. 1 is a diagram schematically illustrating a configuration example of a wireless communication system 1 according to an embodiment. As illustrated in FIG. 1, the wireless communication system 1 includes, for example, two base stations 2-1 and 2-2 and five radio wave reflection devices 3-1 to 3-5, and enables a human (person) A to perform wireless communication in a high frequency band using a wireless terminal 4.

The wireless terminal 4 is, for example, a smartphone or the like having a display screen 40 on its surface. Further, the wireless terminal 4 can transmit compass information indicating an orientation in which the wireless terminal is directed. For example, the wireless terminal 4 can transmit compass information even when the person A is looking at the display screen 40.

For example, when the person A facing north performs an operation while looking at the display screen 40 in front of the person A, the wireless terminal 4 transmits compass information indicating north. The wireless terminal 4 is configured to then be able to communicate with another communication device via either of the base stations 2-1 and 2-2.

The radio wave reflection device 3-1 includes a reflection unit 30 and an imaging unit 31 to be described later, is installed, for example, on the north side of the wireless terminal 4, and reflects and relays the radio waves transmitted by the base station 2-1.

The radio wave reflection device 3-2 includes a reflection unit 30 and an imaging unit 31, is installed, for example, on the northwest side of the wireless terminal 4, and reflects and relays the radio waves transmitted by the base station 2-1.

The radio wave reflection device 3-3 includes a reflection unit 30 and an imaging unit 31, is installed, for example, on the west side of the wireless terminal 4, and reflects and relays the radio waves transmitted by the base station 2-1.

The radio wave reflection device 3-4 includes a reflection unit 30 and an imaging unit 31, is installed, for example, on the south side of the wireless terminal 4, and reflects and relays the radio waves transmitted by the base station 2-2.

The radio wave reflection device 3-5 includes a reflection unit 30 and an imaging unit 31, is installed, for example, on the southeast side of the wireless terminal 4, and reflects and relays the radio waves transmitted by the base station 2-2.

Hereinafter, a case where the wireless terminal 4 itself is at a position where communication with the base station 2-1 can be performed regardless of which of the radio wave reflection devices 3-1 to 3-3 reflects and relays the radio waves transmitted by the base station 2-1, and communication with the base station 2-2 can be performed regardless of which of the radio wave reflection devices 3-4 and 3-5 reflects and relays the radio waves transmitted by the base station 2-2 will be described as an example.

Note that the radio waves transmitted by the base stations 2-1 and 2-2 are radio waves in a high frequency band that may be blocked by the human body when the person A is present in a propagation path.

Therefore, in the example illustrated in FIG. 1, the wireless terminal 4 can communicate with the base station 2-1 regardless of which of the radio wave reflection devices 3-1 to 3-3 reflects and relays the radio waves transmitted by the base station 2-1, and the radio waves transmitted by the base station 2-2 reflected and relayed by the radio wave reflection devices 3-4 and 3-5 are blocked by the person A. Note that a specific operation example of the wireless communication system 1 will be described later.

Next, a specific configuration example of each unit constituting the wireless communication system 1 will be described. Note that in a case where no single configuration is specified among a plurality of configurations such as the radio wave reflection devices 3-1 to 3-5, the configuration is simply abbreviated as the radio wave reflection device 3 or the like.

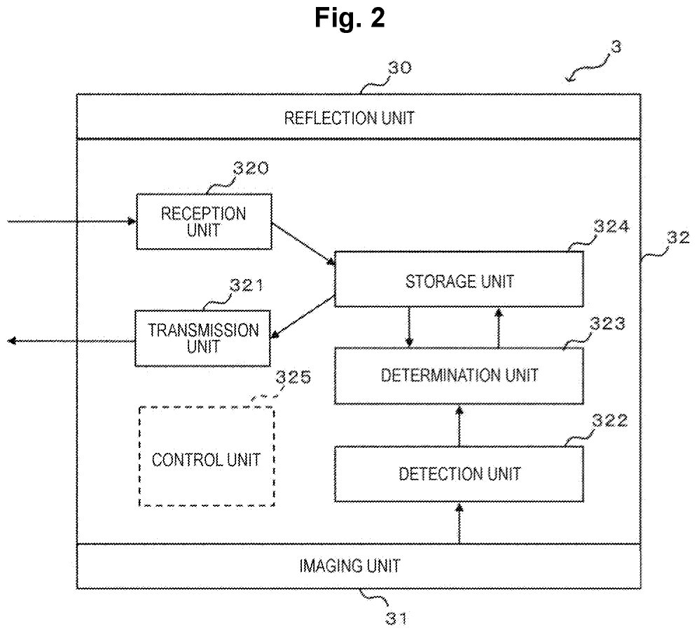

FIG. 2 is a functional block diagram illustrating functions of the radio wave reflection device 3 according to the embodiment. As illustrated in FIG. 2, the radio wave reflection device 3 includes a reflection unit 30, an imaging unit 31, and a main body unit 32.

The reflection unit 30 is a reflector or the like that reflects and relays radio waves transmitted by the base station 2 or the wireless terminal 4 to the wireless terminal 4, the base station 2, or the like.

The imaging unit 31 is, for example, a camera or the like, captures the surroundings of the radio wave reflection device 3 as an image, and outputs the captured image to the main body unit 32.

The main body unit 32 includes a reception unit 320, a transmission unit 321, a detection unit 322, a determination unit 323, a storage unit 324, and a control unit 325.

The reception unit 320 receives radio waves transmitted by the wireless terminal 4 or the base station 2, and stores the received information in the storage unit 324. For example, the reception unit 320 receives compass information transmitted by the wireless terminal 4, a terminal identification code of the wireless terminal 4, and the like, and stores the compass information, the terminal identification code, and the like in the storage unit 324.

The transmission unit 321 transmits radio waves (signals) to the base station 2. For example, the transmission unit 321 transmits line-of-sight information and the like to be described later to the base station 2.

The detection unit 322 acquires an image captured by the imaging unit 31, analyzes and detects the position of a person captured in the image, regards the detected position as, for example, the position of the wireless terminal 4, and outputs the position to the determination unit 323. In addition, the detection unit 322 detects a direction from the radio wave reflection device 3 to the wireless terminal 4 (propagation path direction information) on the basis of an angle at which the imaging unit 31 images a person or the like.

The determination unit 323 acquires the position of the person (the position information of wireless terminal 4) and the propagation path direction information detected by the detection unit 322 from the detection unit 322, and acquires the compass information transmitted by the wireless terminal 4 from the storage unit 324. Also, the determination unit 323 determines whether or not the propagation path between the reflection unit 30 (the radio waves reflected by the reflection unit 30) and the wireless terminal 4 is in a line of sight (LOS) on the basis of the position information, the propagation path direction information, and the compass information of the wireless terminal 4, and outputs line-of-sight information indicating a result of the determination to the storage unit 324.

The storage unit 324 stores the above-described compass information, terminal identification code, position information of the wireless terminal 4, propagation path direction information, line-of-sight information, and the like, and outputs the stored information under the control of the control unit 325.

The control unit 325 controls each unit constituting the radio wave reflection device 3. Specifically, the control unit 325 controls the operation of the imaging unit 31, communication between the radio wave reflection device 3 and the base station 2, and the like.

Note that the radio wave reflection devices 3-1 to 3-5 may be configured to control a radiation unit (such as a dynamic reflector) including a plurality of elements (such as reflective elements) to reflect signals transmitted by the base stations 2-1 and 2-2 toward the wireless terminal 4 and reflect signals transmitted by the wireless terminal 4 toward the base stations 2-1 and 2-2.

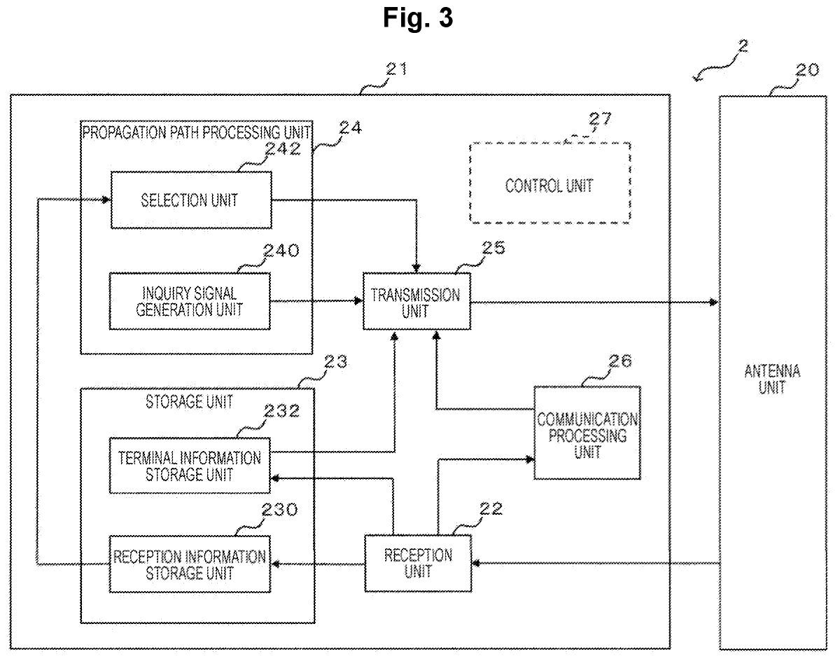

FIG. 3 is a functional block diagram illustrating functions of the base station 2. As illustrated in FIG. 3, the base station 2 includes an antenna unit 20 and a main body unit 21.

The antenna unit 20 includes, for example, a plurality of antennas (not illustrated) and radiates radio waves in a predetermined direction by a phase difference.

The main body unit 21 includes a reception unit 22, a storage unit 23, a propagation path processing unit 24, a transmission unit 25, a communication processing unit 26, and a control unit 27.

The reception unit 22 receives radio waves (signals) transmitted by the radio wave reflection device 3 and the wireless terminal 4 via the antenna unit 20, and outputs predetermined signals to the storage unit 23 and the communication processing unit 26. For example, the reception unit 22 receives the above-described line-of-sight information from each of the radio wave reflection devices 3, and receives a transmission signal (relay signal) to be relayed transmitted by the wireless terminal 4.

The storage unit 23 includes, for example, a reception information storage unit 230 and a terminal information storage unit 232. The reception information storage unit 230 stores, for example, the line-of-sight information and the like transmitted by the radio wave reflection device 3, and outputs the line-of-sight information and the like under the control of the control unit 27. The terminal information storage unit 232 stores, for example, terminal identification information and the like transmitted by the wireless terminal 4, and outputs the terminal identification information and the like under the control of the control unit 27.

The propagation path processing unit 24 includes, for example, an inquiry signal generation unit 240 and a selection unit 242.

The inquiry signal generation unit 240 generates an inquiry signal used by the radio wave reflection device 3 to determine whether or not the propagation path is in a line of sight, and outputs the inquiry signal to the transmission unit 25.

The selection unit 242 acquires each piece of line-of-sight information from the reception information storage unit 230, selects the radio wave reflection device 3 in which the propagation path between the reflection unit 30 and the wireless terminal 4 is in a line of sight on the basis of the line-of-sight information, and outputs the selected result to the transmission unit 25.

In addition, the selection unit 242 may be configured to select the radio wave reflection device 3 having the shortest distance between the reflection unit 30 and the wireless terminal 4 when there are a plurality of radio wave reflection devices 3 in which the propagation path between the reflection unit 30 and the wireless terminal 4 is in the line of sight. Furthermore, the selection unit 242 may select the radio wave reflection device 3 on the basis of the communication quality of uplink communication or downlink communication between the reflection unit 30 and the wireless terminal 4.

The transmission unit 25 transmits signals based on the signals input from the storage unit 23, the propagation path processing unit 24, and the communication processing unit 26 via the antenna unit 20.

The communication processing unit 26 performs a communication process for the wireless terminal 4 to communicate with another communication device. For example, the communication processing unit 26 performs processing for acquiring and processing a signal (relay signal) to be relayed transmitted by the wireless terminal 4 via the antenna unit 20 and the reception unit 22 and transmitting the signal via the transmission unit 25 and the antenna unit 20.

The control unit 27 controls each unit constituting the base station 2 to perform control for selecting the radio wave reflection device 3 that relays a signal to the wireless terminal 4, control for the wireless terminal 4 to communicate with another communication device, and the like. For example, the control unit 27 performs control such that the wireless terminal 4 and the base station 2 perform wireless communication using the radio waves reflected by the radio wave reflection device 3 selected by the selection unit 242.

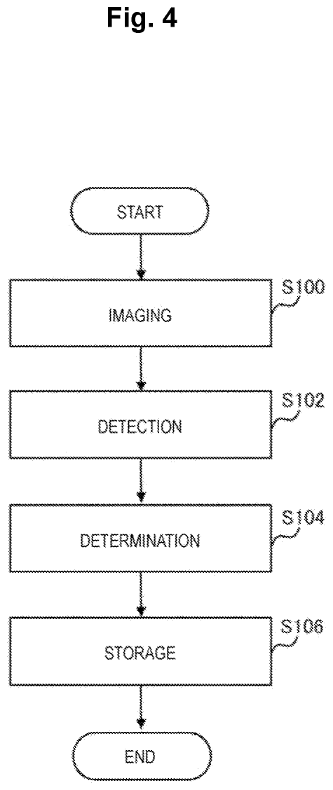

Next, a specific operation example of the wireless communication system 1 will be described. FIG. 4 is a flowchart illustrating an operation example of the radio wave reflection device 3.

First, as illustrated in FIG. 4, each of the radio wave reflection devices 3 captures an image (S100), and detects a position of a person captured in the image on the basis of the captured image (S102).

Then, the radio wave reflection device 3 determines whether or not the propagation path between the reflection unit 30 and the wireless terminal 4 is in a line of sight on the basis of the detected position of the person (position information of the wireless terminal 4) and the compass information transmitted by the wireless terminal 4 (S104).

In addition, the radio wave reflection device 3 stores the compass information, the position information of the wireless terminal 4, the line-of-sight information, and the like (S106).

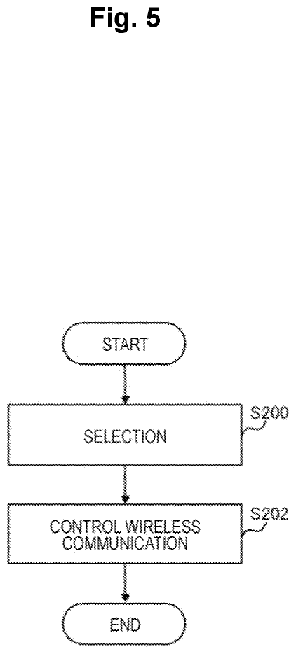

FIG. 5 is a flowchart illustrating an operation example of the base station 2. As illustrated in FIG. 5, the base station 2 selects the radio wave reflection device 3 in which the propagation path between the radio wave reflection device 3 (reflection unit 30) and the wireless terminal 4 is in a line of sight on the basis of each piece of line-of-sight information received from the radio wave reflection device 3 (S200).

Then, the base station 2 performs control such that the wireless terminal 4 and the base station 2 perform wireless communication using the radio waves reflected by the selected radio wave reflection device 3 (S202).

As described above, since the wireless communication system 1 performs control such that the wireless terminal 4 and the base station 2 perform wireless communication using the radio waves reflected by the radio wave reflection device 3 selected by the base station 2, it is possible to prevent the human body from blocking radio waves from the wireless terminal 4 used by a person.

Note that some or all of the functions of the base station 2 and the radio wave reflection device 3 may be configured by hardware such as a programmable logic device (PLD) or a field programmable gate array (FPGA), or may be configured as a program executed by a processor such as a CPU.

For example, the radio wave reflection device 3 according to the present invention can be implemented by using a computer and a program, and the program can be recorded in a storage medium or provided through a network.

### REFERENCE SIGNS LIST

1 Wireless communication system
2-1, 2-2 Base station
3-1 to 3-5 Radio wave reflection device
4 Wireless terminal
20 Antenna unit
21 Main body unit
22 Reception unit
23 Storage unit
24 Propagation path processing unit
25 Transmission unit
26 Communication processing unit
27 Control unit
30 Reflection unit
31 Imaging unit
32 Main body unit
40 Display screen
230 Reception information storage unit
232 Terminal information storage unit
240 Inquiry signal generation unit
242 Selection unit
320 Reception unit
321 Transmission unit
322 Detection unit
323 Determination unit
324 Storage unit
325 Control unit

1. A wireless communication method in which a plurality of radio wave reflection devices reflect radio waves transmitted by a base station toward a wireless terminal capable of transmitting compass information while a person is looking at a display screen, the wireless communication method comprising:
a reflection step in which each of the radio wave reflection devices reflects radio waves with a reflection unit;
an imaging step of capturing an image by each of the radio wave reflection devices;
a detection step of detecting a position of a person captured in the image on the basis of the image captured by each of the radio wave reflection devices;
a determination step of determining whether or not each of propagation paths between the reflection unit and the wireless terminal is in a line of sight on the basis of the detected position of the person and the compass information transmitted by the wireless terminal;
a selection step of selecting the radio wave reflection device in which the propagation path between the reflection unit and the wireless terminal is in the line of sight on the basis of each piece of line-of-sight information indicating a result of the determination; and
a control step of performing control such that the wireless terminal and the base station perform wireless communication using radio waves reflected by the selected radio wave reflection device.

2. The wireless communication method according to claim 1, wherein the selection step includes selecting the radio wave reflection device having a shortest distance between the reflection unit and the wireless terminal when there are a plurality of the radio wave reflection devices in which the propagation path between the reflection unit and the wireless terminal is in the line of sight.

3. A wireless communication system in which a plurality of radio wave reflection devices reflect radio waves transmitted by a base station toward a wireless terminal capable of transmitting compass information while a person is looking at a display screen,
wherein
each of the radio wave reflection devices includes:
a reflection unit configured to reflect a radio wave;
an imaging unit configured to capture an image;
a detection unit configured to detect a position of a person captured in the image on the basis of the image captured by the imaging unit;
a determination unit configured to determine whether or not a propagation path between the reflection unit and the wireless terminal is in a line of sight on the basis of the position of the person detected by the detection unit and the compass information transmitted by the wireless terminal; and
a transmission unit configured to transmit, to the base station, line-of-sight information indicating a result determined by the determination unit, and
the base station includes:
a reception unit configured to receive the line-of-sight information from each of the radio wave reflection devices;
a selection unit configured to select the radio wave reflection device in which the propagation path between the reflection unit and the wireless terminal is in the line of sight on the basis of each piece of the line-of-sight information received by the reception unit; and
a control unit configured to perform control such that the wireless terminal and the base station perform wireless communication using radio waves reflected by the radio wave reflection device selected by the selection unit.

4. The wireless communication system according to claim 3, wherein the selection unit selects the radio wave reflection device having a shortest distance between the reflection unit and the wireless terminal when there are a plurality of the radio wave reflection devices in which the propagation path between the reflection unit and the wireless terminal is in the line of sight.

5. A radio wave reflection device that reflects radio waves transmitted by a base station toward a wireless terminal capable of transmitting compass information while a person is looking at a display screen, the radio wave reflection device comprising:
a reflection unit configured to reflect a radio wave;
an imaging unit configured to capture an image;
a detection unit configured to detect a position of a person captured in the image on the basis of the image captured by the imaging unit;
a determination unit configured to determine whether or not a propagation path between the reflection unit and the wireless terminal is in a line of sight on the basis of a position of a person detected by the detection unit and compass information transmitted by the wireless terminal; and
a transmission unit configured to transmit, to the base station, line-of-sight information indicating a result determined by the determination unit.
